(19) United States
(12) Patent Application Publication
(10) Pub. No.: US 2025/0350003 A1
(43) Pub. Date: Nov. 13, 2025

(54) BATTERY CELL AND METHOD OF MANUFACTURING THE SAME

(71) Applicant: SK ON CO., LTD., Seoul (KR)

(72) Inventor: Yong Hee LEE, Daejeon (KR)

(21) Appl. No.: 19/093,262

(22) Filed: Mar. 28, 2025

(30) Foreign Application Priority Data
May 13, 2024 (KR) 10-2024-0062490

(51) Int. Cl. H01M 50/586; H01M 10/0585; H01M 50/54

(52) U.S. Cl. CPC H01M 50/586; H01M 10/0585; H01M 50/54

(57) ABSTRACT

A battery cell according to an embodiment of the present disclosure may include an electrode assembly in which a plurality of separators are disposed between a plurality of electrode plates; a plurality of electrode tabs extending from the plurality of electrode plates and bonded to an electrode lead; and a plurality of short-circuit blocking portions in which one surface thereof is bonded to the separator, and the other surface thereof is bonded to the electrode tabs to suppress movement of the electrode tab.

### CROSS-REFERENCE TO RELATED APPLICATION(S)

This patent document claims the priority and benefits of Korean Patent Application No. 10-2024-0062490 filed on May 13, 2024, the disclosure of which is incorporated herein by reference in its entirety.

### TECHNICAL FIELD

The disclosure relates to a battery cell and a method of manufacturing the same.

### BACKGROUND

Secondary batteries, unlike primary batteries, may be charged and discharged, and may be applied to devices within various fields, such as digital cameras, mobile phones, laptops, and hybrid cars. Secondary batteries include nickel-cadmium batteries, nickel-metal hydride batteries, nickel-hydrogen batteries, and lithium secondary batteries.

Among these secondary batteries, lithium secondary batteries having high energy density and discharge voltage have been widely researched. Recently, lithium secondary batteries have been used in the form of a battery module or a battery pack connecting multiple flexible pouch-type battery cells.

In such battery cells, electrode assemblies having a plurality of electrodes stacked therein are disposed in a case, and there is a possibility that internal short circuits may occur due to vibrations of a vehicle.

### SUMMARY

According to an aspect of the present disclosure, provided is a battery cell capable of preventing internal short circuits caused by vibrations or shocks and a method of manufacturing the battery cell.

A battery cell according to an embodiment of the present disclosure may include: an electrode assembly in which a plurality of separators are disposed between a plurality of electrode plates; a plurality of electrode tabs extending from the plurality of electrode plates and bonded to an electrode lead; and a plurality of short-circuit blocking portions in which one surface thereof is bonded to the separator, and the other surface thereof is bonded to the electrode tabs to suppress movement of the electrode tab.

In an embodiment, the short-circuit blocking portions may respectively be disposed on both surfaces of the separator, and two short-circuit blocking portions facing each other, among the plurality of short-circuit blocking portions, may be mutually bonded to form a blocking block.

In an embodiment, the electrode tabs may be inserted and disposed in bonded surfaces of the two short-circuit blocking portions forming the blocking block.

In an embodiment, the short-circuit blocking portions may be formed along an edge of the separator and may be elongated in a direction, orthogonal to a direction in which the electrode tabs extend.

In an embodiment, the short-circuit blocking portion may include a thermoplastic polymer.

In an embodiment, the short-circuit blocking portion may be formed of a material in which at least a portion thereof is melted at 100° C. to 150° C.

In an embodiment, the short-circuit blocking portion may be disposed in a region of the separator facing the electrode tab.

In an embodiment, each of the electrode plates may include a metal thin film and an active material applied to at least one surface of the metal thin film, and the short-circuit blocking portion may be disposed in a position spaced apart from the active material by a certain distance.

Additionally, a battery cell according to an embodiment of the present disclosure may include: an electrode assembly in which a plurality of separators are disposed between a plurality of electrode plates; a plurality of electrode tabs extending from the plurality of electrode plates and bonded to an electrode lead; and a blocking block disposed between two separators facing each other, and one of the electrode tabs may be disposed to penetrate through the blocking block.

Additionally, a method of manufacturing the battery cell may include: forming a short-circuit blocking portion in the separator; alternately stacking a plurality of electrode plates and a plurality of the separators; and mutually bonding the short-circuit blocking portions disposed in a row in a stacking direction of the electrode plate and the separator by thermally compressing the short-circuit blocking portions.

In embodiment, the forming a short-circuit blocking portion may include applying a thermoplastic polymer to each of both surfaces of the separator along an edge of the separator.

In embodiment, the mutually bonding the short-circuit blocking portions may include forming a blocking block by mutually bonding two short-circuit blocking portions facing each other with one electrode tab interposed therebetween, among the plurality of short-circuit blocking portions.

According to one embodiment of the present disclosure, since a plurality of electrodes and a plurality of separators may be interconnected by a blocking block and may be formed integrally, it may be possible to prevent the separators or electrodes from moving due to external shocks or vibrations, thereby suppressing the occurrence of short circuits between the electrodes.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating a battery cell according to an embodiment of the present disclosure.

FIG. 2 is an exploded perspective view of FIG. 1.

FIG. 3 is a cross-sectional view taken along line I-I′ of FIG. 1.

FIG. 4 is an enlarged cross-sectional view of the electrode assembly of FIG. 3.

FIG. 5 is a plan view of FIG. 4.

FIGS. 6 and 7 are cross-sectional views illustrating a method of manufacturing a battery cell according to this embodiment.

FIG. 8 is a flowchart illustrating a method of manufacturing a battery cell according to this embodiment.

### DETAILED DESCRIPTION

Hereinafter, the present disclosure will be described in detail with reference to the attached drawings. However, this is only exemplary and the present disclosure is not limited to the specific embodiments described as exemplary.

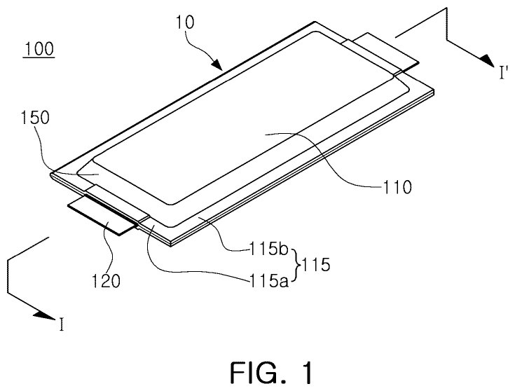

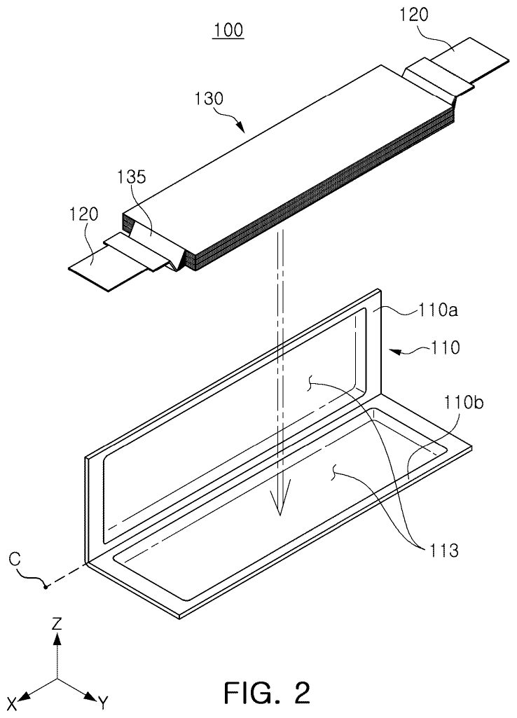

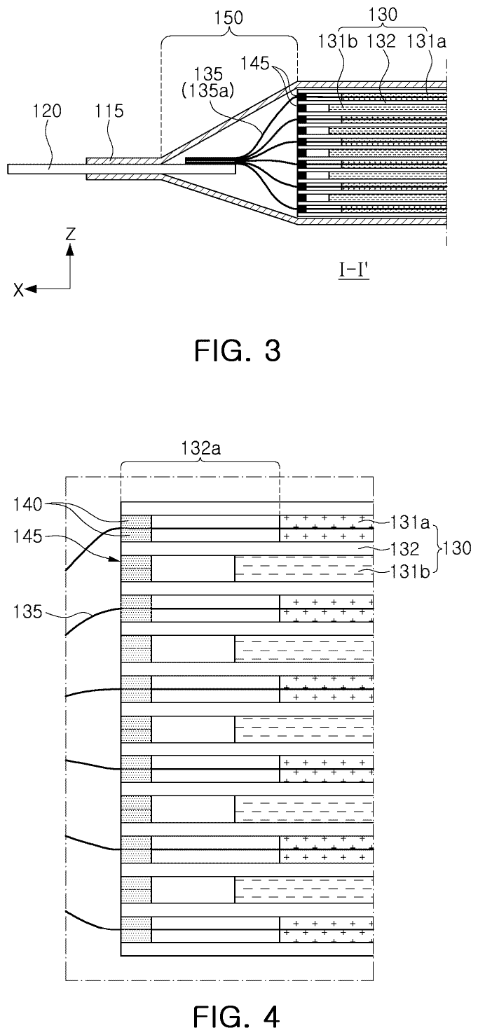

FIG. 1 is a perspective view schematically illustrating a battery cell according to an embodiment of the present disclosure, FIG. 2 is an exploded perspective view of FIG. 1, and FIG. 3 is a cross-sectional view taken along line I-I′ of FIG. 1.

Referring to FIGS. 1 to 3, a battery cell 100 according to an embodiment may include an electrode assembly in which a plurality of separators are disposed between a plurality of electrode plates, a plurality of electrode tabs extending from the plurality of electrode plates and bonded to an electrode lead, and a plurality of short-circuit blocking portions in which one surface thereof is bonded to the separator and the other surface is bonded to the electrode tabs to suppress movement of the electrode tab. The battery cell 100 may also include a case 110 protecting the electrode assembly.

The battery cell 100 according to an embodiment is a rechargeable secondary battery, and may include a lithium ion (Li-ion) battery or a nickel metal hydride (Ni-MH) battery. The nickel metal hydride battery is a secondary battery that uses nickel as a cathode, a hydrogen-storing alloy as an anode, and an alkaline aqueous solution as an electrolyte, and has a large capacity per unit volume, so that the nickel metal hydride battery may be used as an energy source for electric vehicles (EV) or hybrid electric vehicles (HEVs), and may also be used in various fields such as energy storage.

The battery cell 100 may have a pouch-type structure. The case 110 may be used by insulating a surface of a metal layer formed of, for example, aluminum. An insulating treatment may be performed by applying modified polypropylene, which is a polymer resin, to the surface of the metal layer and stacked a resin material such as nylon or polyethylene terephthalate (PET) on an outer surface thereof.

In the case 110, an accommodation space 113 in which an electrode assembly 130 is accommodated may be provided. Additionally, an electrode lead 120 may be protrudingly disposed on the outside of the case 110.

As illustrated in FIG. 2, the battery cell 100 of the present embodiment may seal the accommodation space 113 by folding a single sheet of outer material and bonding three side surfaces. Accordingly, the case 110 of this embodiment may be divided into a first case 110a and a second case 110b based on a folding line (C) on which the outer material is folded.

Specifically, the battery cell 100 of this embodiment may be manufactured by accommodating the electrode assembly 130 in the accommodation space 113, folding the outer material along the folding line (C), and then bonding edges at which the first case 110a and the second case 110b meet and sealing the accommodation space 113.

A heat-melting method may be used as an edge bonding method, but the present disclosure is not limited thereto. Hereinafter, a bonded edge portion is referred to as a sealing portion 115.

In an embodiment, the sealing portion 115 may be divided into a first sealing portion 115a formed in a portion in which the electrode lead 120 is disposed, and a second sealing portion 115b formed in a portion in which the electrode lead 120 is not disposed.

The sealing portion 115 may be formed in a flange shape extending outward from the accommodation space 113. Accordingly, the sealing portion 115 may be disposed along an outer perimeter of the accommodation space 113.

Meanwhile, in this embodiment, a case in which a battery cell is manufactured by folding the outer material was given as an example, but the present disclosure is not limited thereto, and the first case 110a and the second case 110b may also be formed of separate outer materials. In this case, the sealing portion 115 may be disposed on all four side surfaces of the accommodation space 113.

Additionally, the battery cell 100 of an embodiment may be provided with the accommodation space 113 in each of the first case 110a and the second case 110b. However, the configuration of the present disclosure is not limited thereto, and various modifications are possible, such as providing the accommodation space 113 in only one of the first case 110a and the second case 110b.

The electrode assembly 130 may be stored together with the electrolyte in an inner accommodation space 113 of the case 110.

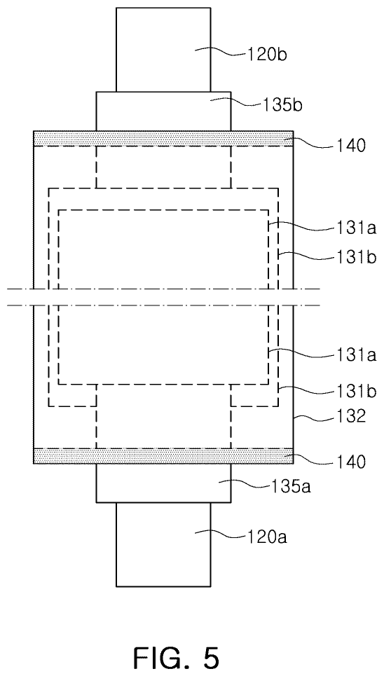

FIG. 4 is an enlarged cross-sectional view of the electrode assembly of FIG. 3, and FIG. 5 is a plan view of the electrode assembly illustrated in FIG. 3.

Referring to FIGS. 4 and 5 together, the electrode assembly 130 may include a plurality of electrode plates 131a and 131b divided into a cathode plate 131a and an anode plate 131b, and a separator 132 disposed between the cathode plate 131a and the anode plate 131a.

The electrode plates 131a and 131b may be formed by applying a cathode active material or an anode active material to one surface or both surfaces of a metal thin film. Additionally, the electrode assembly 130 may be provided in a form in which a plurality of cathode plates 131a and a plurality of anode plates 131b are alternately stacked.

An electrode tab 135 may be disposed between the electrode assembly 130 and the sealing portion 115. The electrode tab 135 may include a cathode tab 135a extending from the cathode plate 131a and an anode tab 135b extending from the anode plate 131b.

The electrode tab 135 may be formed of the metal thin film described above. For example, the electrode tab 135 may be formed as a region of a metal thin film to which the active material is not applied.

The electrode tab 135 may extend from each of the electrode plates 131a and 131b and may be bonded to each other with the same polarity, and at least portions of the electrode tabs may be disposed in a terrace 150 (see FIG. 3). In an embodiment, the terrace 150 may correspond to a perimeter of a portion of the case 110 accommodating the electrode assembly 130. Additionally, the terrace 150 may be defined as a portion corresponding to the electrode assembly 130 and the sealing portion 115 of the case 110.

In an embodiment, the electrode tab 135 is drawn out toward the first sealing portion 115a. Accordingly, the terrace 150 of this embodiment may include a region between the electrode assembly 130 and the first sealing portion 115a.

However, even if the electrode tab 135 is not accommodated, any free space formed between the electrode assembly 130 and the sealing portion 115, or any portion in which the battery cells 100 are not pressurized (or contacted) with each other during stacking of the battery cells 100, may be included in the terrace 150. For example, the terrace 150 may include a section in which a thickness of the battery cell 100 gradually decreases toward the sealing portion 115.

The separator 132 is disposed between the cathode plate 131a and the anode plate 131a to electrically/physically separate the cathode plate 131a and the anode plate 131b. The separator 132 is disposed over an entire region in which the cathode plate 131a and the anode plate 131a face each other, thus preventing contact between the cathode plate 131a and the anode plate 131a.

The separator 132 of this embodiment may include an extension portion 132a disposed to protrude outwardly from a stack region in which the cathode plate 131a and the anode plate 131a are stacked. The stack region may refer to a region in which the active material of the cathode plate 131a and the active material of the anode plate 131a are stacked with each other. Accordingly, the extension portion 132a may be understood as a portion of the separator 132 that does not face or contact the active material. Additionally, the extension portion 132a may be understood as a portion of the separator 132 that is disposed between the electrode tabs 135.

The electrode lead 120 may electrically connect the battery cell 100 to another external device. One end of the electrode lead 120 may be bonded to the electrode tab 135 and may be electrically connected to the electrode assembly 130, and the other end thereof may extends in an X-axis direction and may be exposed to the outside of the case 110.

The electrode lead 120 may include a cathode lead 120a connected to the cathode tab 135a and an anode lead 120b connected to the anode tab 135b.

The cathode lead 120a and the anode lead 120b may be formed of a thin plate-shaped metal. For example, the cathode lead 120a may be formed of aluminum (Al) material, and the anode lead 120b may be formed of copper (Cu) material. However, the present disclosure is not limited thereto.

In an embodiment, the cathode lead 120a and the anode lead 120b are disposed to face opposite directions to each other, and the cathode lead 120a and the anode lead 120b are disposed to protrude from both sides of the case 110. However, the configuration of the present disclosure is not limited thereto, and various modifications are possible as needed, such as disposing the cathode lead 120a and the anode lead 120b to face the same direction.

The battery cell 100 described above is may cause an electrode short circuit when the electrode plates 131a and 131b are pushed by external shocks or vibrations during an operation process, and in this case, an explosion or fire accident of the battery cell 100 may occur.

Accordingly, in order to prevent the above-mentioned problem, the battery cell 100 of this embodiment may be provided with at least one short-circuit blocking portion 140.

The following description is based on the cathode tab 135a of the electrode assembly 130, but the same description manner as that of the cathode tab 135a may be applied to the anode tab 135b.

The short-circuit blocking portion 140 may be formed in the extension portion 132a of the separator 132.

The short-circuit blocking portion 140 may be formed on both surfaces of the separator 132, and may be disposed in a region facing the electrode tab 135. Additionally, among the plurality of short-circuit blocking portions 140, two short-circuit blocking portions 140 facing each other may be bonded to each other to form a blocking block 145 described below.

The short-circuit blocking portion 140 may be formed by applying an insulating material to the separator 132, and the short-circuit blocking portion 140 may be formed in the form of an insulating layer having a certain thickness. In an embodiment, a thickness of the short-circuit blocking portion 140 may be formed by corresponding to a thickness of the electrode plates 131a and 131b, and may be formed to a thickness of, for example, 10 μm to 100 μm.

The short-circuit blocking portion 140 of an embodiment may be formed along an edge of the separator 132. For example, the short-circuit blocking portion 140 may be formed along an end of the extension portion 132a, and may be elongated in a second direction (Y-axis direction), orthogonal to the first direction (X-axis direction), in which the electrode tab 135 extends from the electrode assembly 130.

In an embodiment, since a plurality of separators 132 are stacked, the short-circuit blocking portions 140 may be formed on each separator 132, and the short-circuit blocking portions 140 of each separator 132 may be formed in a position in which the short-circuit blocking portions 140 face each other. The short-circuit blocking portion 140 of this embodiment may be disposed in a position spaced apart from an active material by a certain distance so as not to come into contact with the active material of the anode plate 131b or the cathode plate 131a. For example, a width of the short-circuit blocking portion 140 may be formed to be 1 mm to 10 mm.

However, this embodiment is not limited thereto, and if necessary, at least a portion of the short-circuit blocking portion 140 may be formed to be in contact with the active material.

The short-circuit blocking portion 140 may be formed of an electrically insulating material such as a resin or polymer. Additionally, the short-circuit blocking portion 140 formed on each separator 132 may be finally mutually bonded to another short-circuit blocking portion 140 to form a blocking block 145.

For example, an electrode tab 135 may be disposed between two separators 132 sequentially stacked, and thereamong, a short-circuit blocking portion 140 formed on an upper surface of the lower separator 132 and a short-circuit blocking portion 140 formed on a lower surface of the upper separator 132 may be mutually bonded to each other to form a blocking block 145. In this case, the electrode tab 135 disposed between the lower separator 132 and the upper separator 132 may be fixed in a state of being inserted into the inside of the above-described block 145.

In this manner, the blocking block 145 of this embodiment may be formed by mutually bonding two short-circuit blocking portions 140 facing each other with one electrode tab 135 interposed therebetween. Accordingly, the blocking block 145 may refer to a state in which two short-circuit blocking portions 140 disposed to face each other are bonded integrally, and one of the electrode tabs 135 may be inserted and disposed into a bonded surface of the two short-circuit blocking portions 140 included in the blocking block 145. As a result, one of the electrode tabs 135 may be disposed to penetrate the blocking block 145.

To this end, the short-circuit blocking portion 140 may include a thermoplastic polymer that may be bonded to each other when applying heat. For example, the short-circuit blocking portion 140 may include polymers such as Polyphthalamide (PPA), polypropylene (PP), and polyethylene (PE). However, the present disclosure is not limited thereto, and when the short-circuit blocking portions 140 may be bonded together in a state in which the electrode plates 131a and 131b and the separator 132 are stacked, various materials may be used.

On the other hand, when a temperature applied to the short-circuit blocking portion 140 is less than 100° C., the heat applied to the short-circuit blocking portion 140 may be insufficient, which may lower the reliability of the bonding between the short-circuit blocking portions 140. Additionally, in the case of the separator 132, heat shrinkage may occur at 160° C. or higher. Accordingly, considering the bonding reliability of the short-circuit blocking portions 140 and the heat shrinkage of the separator 132, the short-circuit blocking portion 140 of this embodiment may be formed of a material in which at least a portion thereof is melted at 100° C. to 150° C.

As the short-circuit blocking portions 140 are mutually connected to form a blocking block 145, the plurality of separators 132 may be connected to each other by the blocking blocks 145. Additionally, since the plurality of electrode tabs 135 are fixedly connected to the blocking block 145, the plurality of electrode plates 131a and 131b may also be connected to each other by the blocking blocks 145.

In this manner, the electrode assembly 130 of this embodiment may be formed integrally by mutually connecting all of the plurality of electrode plates 131a and 131b and the plurality of separators 132 by the blocking blocks 145. Accordingly, it may be possible to suppress occurrence of a short circuit between the electrode plates 131a and 131b by causing the separator 132 or the electrode plates 131a and 131b to move due to external shocks or vibrations.

Next, a method of manufacturing a battery cell according to an embodiment will be described.

The method of manufacturing a battery cell according to an embodiment may include an operation of forming a short circuit blocking portion 140 at an edge of a separator 132, an operation of alternately stacking a plurality of electrode plates 131a and 131b and a plurality of separators 132, and an operation of mutually bonding the short circuit blocking portions 140 by thermally compressing the short circuit blocking portions 140 disposed in a row in a stacking direction of the electrode plates 131a and 131b and the separator 132.

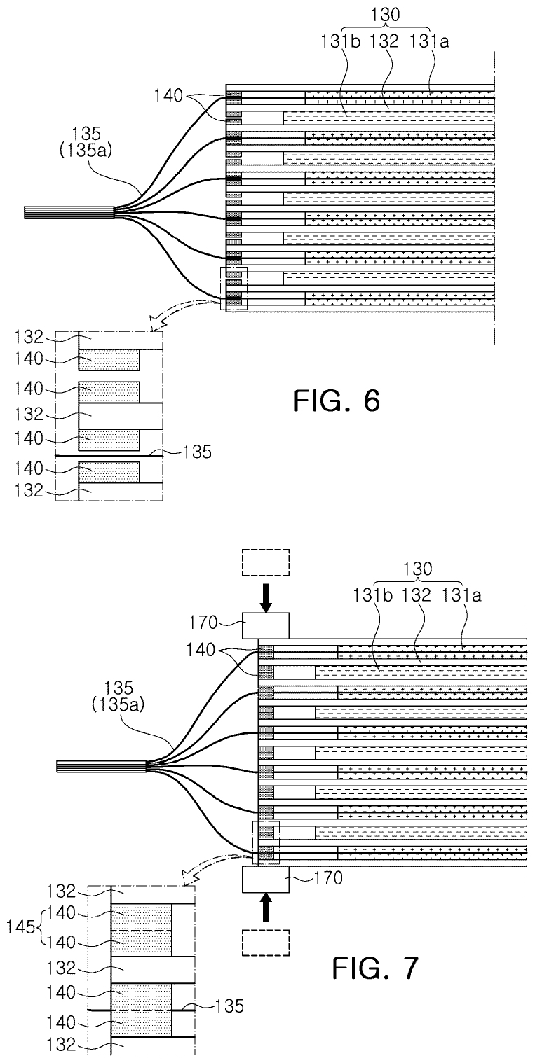

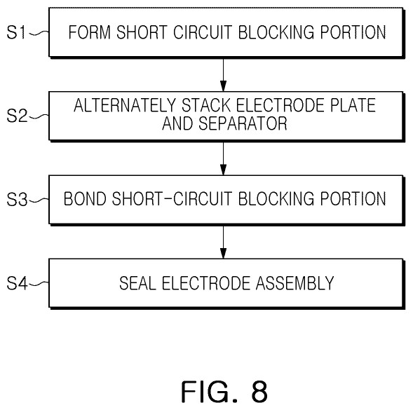

FIG. 6 and FIG. 7 are cross-sectional views illustrating a method of manufacturing a battery cell according to an embodiment, and FIG. 8 is a flow chart of a method of manufacturing a battery cell according to an embodiment.

Referring to FIGS. 6 and 8 together, the method of manufacturing a battery cell according to an embodiment may first perform an operation (S1) of forming a short circuit blocking portion 140 on a separator 132. This operation may include an operation of applying a thermoplastic polymer to both surfaces of the separator 132 along an edge of the separator 132. For example, this operation may include an operation of applying a liquid thermoplastic polymer to both edges of the separator 132 supplied in a strip form from a roll using a slot die, or the like, and an operation of curing the applied thermoplastic polymer to form a short-circuit blocking portion 140.

Next, an operation (S2) of alternately stacking a plurality of electrode plates 131a and 131b and a plurality of separators 132 may be performed. As illustrated in FIG. 6, a plurality of cathode plates 131a and a plurality of anode plates 131b may be alternately stacked, and a separator 132 may be repeatedly placed between the cathode plates 131a and the anode plates 131a.

In this process, the short-circuit blocking portion 140 may be disposed on the outside of the active material formed on the cathode plate 131a and the anode plate 131a. Additionally, the plurality of separators 132 may be stacked so that the short-circuit blocking portions 140 are disposed in a row in a stacking direction (Z-direction of FIG. 3) of the electrode plates 131a and 131b.

Then, an operation (S3) of thermally compressing and bonding the short-circuit blocking portions 140 may be performed. This operation may include an operation of forming a blocking block 145 by mutually bonding two short-circuit blocking portions 140 facing each other with one electrode tab 135 interposed therebetween, among the plurality of short-circuit blocking portions.

To this end, this operation may include an operation of disposing pressurized blocks 170 on an upper portion and a lower portion of the short-circuit blocking portions 140 disposed in a row in the stacking direction of the electrode plates 131a and 131b and the separator 132, and an operation of mutually bonding the short-circuit blocking portions 140 by thermally compressing the short-circuit blocking portions 140 with the pressurized blocks 170.

As illustrated in FIG. 7, when the pressurizing blocks 170 pressurize the short-circuit blocking portion 140, two short-circuit blocking portions 140 facing each other may be in contact with each other with the electrode tab 135 of the plurality of short-circuit blocking portions 140 interposed therebetween. Accordingly, the pressurizing block 170 may mutually bond the short-circuit blocking portions 140 by applying heat to the short-circuit blocking portions 140 in a state in which the short-circuit blocking portions 140 are in contact.

To this end, the pressurizing blocks 170 may be disposed so as to be able to move in an up-and-down direction, and a heat source applying heat to the pressurizing block 170 may be disposed inside or outside the pressurizing block 170.

As described above, in the case of the separator 132, heat shrinkage may occur at 160° C. or higher, and if the temperature of the pressurizing block 170 is less than 100° C., the heat applied to the short-circuit blocking portion 140 may be insufficient, which may lower the reliability of the bonding between the short-circuit blocking portions 140. Accordingly, the pressurizing block 170 of this embodiment may apply heat to the short-circuit blocking portion 140 in a temperature range of 100° C. to 150° C.

When a plurality of blocking blocks 145 are formed through the above-described heat compression process, the pressurizing block 170 may be returned to an original position thereof, and then, an operation (S4) of sealing the electrode assembly 130 to the case 110 may be performed. As illustrated in FIG. 3, the electrode assembly 130 may be accommodated in the case 110 after the electrode lead 120 is bonded to the electrode tab 135 and may be sealed inside the case 110 together with the electrolyte.

In an embodiment, a case in which the blocking block 145 is formed and then the electrode lead 120 is bonded to the electrode tab 135 is exemplified, but if necessary, the electrode lead 120 may be first bonded to the electrode tab 135 first and then, the blocking block 145 may be formed.

Although the embodiments of the present disclosure have been described in detail above, the scope of the present disclosure is not limited thereto, and it will be apparent to those skilled in the art that various modifications and variations are possible within a scope that does not depart from the technical concept 4 present disclosure described in the claims.

What is claimed is:

1. A battery cell, comprising:
an electrode assembly in which a plurality of separators are disposed between a plurality of electrode plates;
a plurality of electrode tabs extending from the plurality of electrode plates and bonded to an electrode lead; and
a plurality of short-circuit blocking portions in which one surface thereof is bonded to the separator, and the other surface thereof is bonded to the electrode tabs to suppress movement of the electrode tab.

2. The battery cell of claim 1,
wherein the short-circuit blocking portions are respectively disposed on both surfaces of the separator, and
two short-circuit blocking portions facing each other, among the plurality of short-circuit blocking portions, are mutually bonded to form a blocking block.

3. The battery cell of claim 2,
wherein the electrode tabs are inserted and disposed in bonded surfaces of the two short-circuit blocking portions forming the blocking block.

4. The battery cell of claim 2,
wherein the short-circuit blocking portions are formed along an edge of the separator and are elongated in a direction, orthogonal to a direction in which the electrode tabs extend.

5. The battery cell of claim 2,
wherein the short-circuit blocking portion includes a thermoplastic polymer.

6. The battery cell of claim 2,
wherein the short-circuit blocking portion is formed of a material in which at least a portion thereof is melted at 100° C. to 150° C.

7. The battery cell of claim 1,
wherein the short-circuit blocking portion is disposed in a region of the separator facing the electrode tab.

8. The battery cell of claim 7,
wherein each of the electrode plates includes a metal thin film and an active material applied to at least one surface of the metal thin film, and
the short-circuit blocking portion is disposed in a position spaced apart from the active material by a certain distance.

9. A battery cell, comprising:
an electrode assembly in which a plurality of separators are disposed between a plurality of electrode plates;
a plurality of electrode tabs extending from the plurality of electrode plates and bonded to an electrode lead; and
a blocking block disposed between two separators facing each other,
wherein one of the electrode tabs is disposed to penetrate through the blocking block.

10. A method of manufacturing the battery cell, comprising:
forming a short-circuit blocking portion in the separator;
alternately stacking a plurality of electrode plates and a plurality of the separators; and
mutually bonding the short-circuit blocking portions disposed in a row in a stacking direction of the electrode plate and the separator by thermally compressing the short-circuit blocking portions.

11. The method of manufacturing the battery cell of claim 10, wherein the forming a short-circuit blocking portion includes,
applying a thermoplastic polymer to each of both surfaces of the separator along an edge of the separator.

12. The method of manufacturing the battery cell of claim 10, wherein the mutually bonding the short-circuit blocking portions includes,
forming a blocking block by mutually bonding two short-circuit blocking portions facing each other with one electrode tab interposed therebetween, among the plurality of short-circuit blocking portions.
